(19) United States
(12) Patent Application Publication
(10) Pub. No.: US 2017/0049655 A1
(43) Pub. Date: Feb. 23, 2017

(54) CHAIR HAVING NECK EXERCISE SUPPORT FOR NECK EXERCISE

(71) Applicant: Tae-Soo SUNG, Seoul (KR)

(72) Inventor: Tae-Soo SUNG, Seoul (KR)

(21) Appl. No.: 15/118,650

(22) PCT Filed: Feb. 16, 2015
(86) PCT No.: PCT/KR2015/001556

§ 371 Date: Aug. 12, 2016

(30) Foreign Application Priority Data
Feb. 14, 2014 (KR) 10-2014-0017294
Feb. 16, 2015 (KR) 10-2015-0023027

(51) Int. Cl. A61H 1/00; A63B 23/025; A47C 7/00; A47C 7/38; A47C 7/54

(52) U.S. Cl. CPC A61H 1/008; A47C 7/38; A47C 7/54; A47C 7/006; A47C 7/004; A63B 23/025; A61H 2205/04; A61H 2201/1611

(57) ABSTRACT

As a method for achieving the objective of the present invention, provided is a neck exercise support for neck exercise formed in the upper part of a chair, the neck exercise support comprising: a contact plate which is to be in contact with the head; a central hole which forms an empty space in the center of the contact plate; a first insert hole which transversely penetrates the interior of the contact plate; a contact plate support which is configured so as to support the contact plate; a second insert hole which is transversely formed in the center of the contact plate support to correspond to the first insert hole of the contact plate; a coupling part which penetrates the first insert hole and the second insert hole; a contact plate support through-hole which is formed in the vertical direction with respect to the second insert hole; and a pair of first coupling rods which are coupled with the contact plate support through-hole; wherein the contact plate is coupled with the contact plate support via the coupling part, and the contact plate support coupled with the coupling part is connected through the first coupling rods.

### TECHNICAL FIELD

The present invention relates to a neck rest (a head rest) which is attached to an office chair, a vehicle seat, etc. and in particular to a chair having a neck rest wherein a user's neck muscle can be strengthened since a neck exercise is carried out in such a way that a neck rest can be tilted backward during a neck exercise wherein a neck rest attached to a chair is pushed by supplying a force to the back of a head, and a cervical vertebral is pulled as a lower portion of the neck rest rises at the moment the neck rest is tilted backward, and the cervical vertebral is pulled during a neck exercise carried out to obtain a pulling effect to the cervical vertebral.

The above mentioned two matters are the original objects of the present invention.

The related field of the present invention may be directed to an acupressure since an acupressure effect to a shoulder can be provided in such a way to attach a simple device to the basic structure employed for the sake of the aforementioned objects.

### BACKGROUND ART

The present invention belongs to a field wherein a user's neck muscle can be strengthened, and more specifically a technical field wherein a narrowed intervertebral disc can be expanded.

As a conventional means which in general is used in a physical therapy room,

the conventional technology is using a complicated mechanism when it needs to pull a head to its crown after the jaw and the back of the top of the head are wrapped in a lain posture, and a part of the office chair is using a head rest, but all these technologies are using a method wherein the jaw and the back of the top of the head are wrapped and then are pulled.

The conventional technology is as follows.

As illustrated in the first part in FIG. 15, the jaw and the back of the head are wrapped with a cloth and then are pulled upward, which corresponds to the most primitive method.

As illustrated in the second part in FIG. 15, the neck of wrapped in a tube type, and the neck is stretched using air.

As illustrated in the third and fourth parts in FIG. 15, the head rest attached to the chair is used, and the jaw is supported and pulled upward using a hydraulic pressure, of which the third part in FIG. 15 shows that the head rest is operated leftward and rightward, and the fourth part in FIG. 15 shows a technology wherein the head rest is jointly used by operating upward and downward.

### DISCLOSURE OF INVENTION

As for the solutions to be solved by the present invention,

it is a first object of the present invention to increase the amount of muscles of a neck since a basic therapy can be carried out in such a way to strengthen neck muscles.

It is a second object of the present invention to expand the interval of the narrowed cervical vertebral.

It is a third object of the present invention to provide an acupressure to the surrounding of a shoulder since a person having a pain in the neck may also have a pain in the muscles near the neck.

It is a fourth object of the present invention to provide convenience when in use.

It is a fifth object of the present invention to enhance efficiency so that everyone is able to easily use thanks to the enhanced accessibility.

### Solution of Tasks

To achieve the above objects, as a solution to resolve the aforementioned problems,

there is provided a chair having a neck exercise support for a neck exercise, which is provided at the top of a chair, which may include, but is not limited to,

a contact plate which is to be in contact with the head;

a central hole which forms an empty space in the center of the contact plate;

a first insert hole which transversely penetrates the interior of the contact plate;

a contact plate support which is configured so as to support the contact plate;

a second insert hole which is transversely formed in the center of the contact plate support to correspond to the first insert hole of the contact plate;

a coupling part which penetrates the first insert hole and the second insert hole;

a contact plate support through hole which is formed vertical with respect to the second insert hole; and

a pair of first coupling rods which are coupled with a contact plate support through hole,

wherein the contact plate is coupled via the coupling part to the contact plate support, and the contact plate support coupled with the coupling part is connected via the first coupling rod.

Moreover, a neck acupressure rod is disposed below the contact plate.

In addition, the coupling part may be formed of various components, but it is formed of a coupling pin in the present invention.

Furthermore, a curved part corresponding the shape of the neck is provided at the front sides of the contact plate and the neck exercise support for the neck to be mounted thereon.

Moreover, the first coupling rod further includes a contact plate spring.

In addition, the neck exercise support includes at its backside a spring having a predetermined elasticity.

Furthermore, the spring is formed of a torsion spring.

Moreover, there is further provided a first rotary shaft which is disposed in a vertical direction with respect to the first coupling rod.

In addition, a bottom plate of the neck exercise support is formed extended about the first rotary shaft.

Furthermore, there may be further provided a support plate having a neck exercise support groove in which the first rotary shaft is inserted.

Moreover, an assistant support plate is disposed below the support plate, and the assistant support plate includes a second coupling rod for the sake of a connection with the support plate.

In addition, a corresponding engaging rod insert hole is provided for the sake of a connection with the second coupling rod.

The second coupling rod includes a support plate spring.

Moreover, the assistant support plate includes a support rod for the sake of an engagement to a main body of the chair.

In addition, the support rod further includes a back plate spring.

Furthermore, an elastic means is provided inside of the neck exercise support groove, and the elastic means is formed of a pocket spring.

Moreover, an acupressure rod fixing plate is disposed below the assistant support plate.

The acupressure rod fixing plate includes a shoulder acupressure rod part.

In addition, the shoulder acupressure rod part includes a bolt, a handle installed at an end of the bolt so as to allow the bolt to move back and forth, and a fixing pin which is installed at the other end of the bolt so as to lock or unlock the bolt, wherein there are provided the bolt and a handle shoulder acupressure rod.

Furthermore, the shoulder acupressure rod part includes a rail box for the sake of an engagement with the acupressure rod fixing plate.

Moreover, the shoulder acupressure rod part is connected via an ascending rod, so it can ascend or descend via a chair handle, and there is provided an ascending lever to ascend or descend the ascending rod.

Furthermore, an ascending and descending locking part includes a second bolt, a sliding lock which is able to allow the second bolt to move back and forth, and a cable which is able to allow the sliding lock to move back and forth, wherein a third rotary shaft is provided at the ascending lever for the ascending lever to ascend when the cable is pulled.

### Advantageous Effects of the Invention

A disc disease is inevitable to a human who walks upward. According to a working environment of a modern person, a worker works in a sitting posture all day, so the spine and the cervical vertebral are pressed against each other all day. In this situation, different from other muscles, there is not any way to strength the muscles of the cervical vertebral. The typical exercise of the neck is carried out in such a way to rotate the neck leftward or rightward or move the head in forward, backward, leftward or rightward directions.

The common way of a neck exercise may be carried out in such a way that the muscles are strengthened using the force of pushing each other corresponding to the force of a right hand with the head being in the rightward direction while strongly pushing in the leftward direction a rightward head portion of the top of an ear using the palm of the right hand. Moreover, as mentioned above, the neck exercise may be carried out using the force which pushes in the opposite direction. Here, the muscles of the cervical vertebral can be strengthened while the force is supplied to the neck due to the pushing force. This exercise, however, cannot effectively prevent the disc of the cervical vertebral of the neck from being pressed against each other. It is hard for a person to do even this kind of exercise by making time.

Consequently, the muscles of the neck may become weak, and the neck is continuously pressed, and the intervertebral disc may be pressed. The aforementioned ways are used so as to resolve the above problems.

The common feature of the above devices are that the head does not move after it has been pulled upward. This way may cause a problem since the head is fixed after it has been pulled. In this case, the muscles cannot be strengthened.

In the exercise for strengthening the muscles of the neck, there is not any occasion wherein any tool is used except for the aforementioned free exercises. When it needs to strengthen the muscles of the arms and legs, the amount of the muscles are strengthened using a heavy tool, for example, a dumbbell or a barbell. In case of the neck, as mentioned above, a free exercise is only a solution, wherein the neck is rotated in forward, backward, leftward and rightward directions or the neck is bent. The present invention, however, is directed to an exercise since the action of strongly pressing with the neck is repeatedly carried out, which means that the dumbbell is lifted up with the neck. In this way, it is possible to greatly increase the amount of muscles compared to the free exercises, which may become a key solution to the neck disease.

Moreover, when the neck is pushed backward in the way described above, it is possible to obtain a good pulling effect, which means that two effects can be obtained at a time. As another effect, the present invention may allow everyone to easily carry out a necessary exercise. The tools in the physical therapy room cannot provide desired effects, and everyone cannot easily do exercise using such tools. The present invention is able to allow people to easily do exercises since the chair that the people usually use is used. The user is able to do exercises even when working at an office or driving a vehicle. For the exercise, only the necessary action the user must do is to tilt his head backward. If a simple device is further added, the user can receive an acupuncture effect to his shoulder.

### BRIEF DESCRIPTION OF DRAWINGS

FIG. 1 is a perspective view of the present invention.

FIG. 2 is a view illustrating an inner configuration of a back plate.

FIG. 3 is a view illustrating a contact plate.

FIG. 4 is a contact plate support part.

FIG. 5 is a view illustrating a coupled state of a contact plate and a contact plate support part.

FIG. 6 is a front view illustrating a main body.

FIG. 7 is a rear view illustrating a main body.

FIG. 8 is a view illustrating a coupled state of a contact plate, a contact plate support part and a main body.

FIG. 9 is a disassembled view illustrating a support plate.

FIG. 10 is a view illustrating a coupled state of a support plate.

FIG. 11 is a view illustrating a coupled state of a contact plate, a contact plate support part, a main body and a support plate.

FIG. 12 is a view for describing a motion phenomenon of a cervical vertebral.

FIG. 13 is a view for describing an organic motion of a spine and a cervical vertebral.

FIG. 14 is a whole view for describing a motion procedure and a pulling procedure.

FIG. 15 is a view for describing the concept of a conventional method.

FIG. 16 is a view for describing the contact of a rest rod.

FIG. 17 is a perspective view illustrating an acupuncture pin (the left side is a disassembled view, and a right side is a coupled view).

FIG. 18 is a view illustrating a coupled state of a support plate.

FIG. 19 is a view illustrating a coupled state of a main body and an ascending rod in FIG. 6.

FIG. 20 is a view illustrating a coupling type of an ascending rod in FIG. 11.

FIG. 21 is a disassembled view illustrating an ascending bar.

FIG. 22 is a view illustrating a coupled state of an ascending bar.

FIG. 23 is a whole view illustrating a state wherein the configuration in FIG. 20 is engaged to a chair.

FIG. 24 is a view illustrating a state wherein an ascending bar cable and a bite cable are connected to a chair handle.

FIG. 25 is a view for describing an operation wherein a bite is operated by a bite cable.

FIG. 26 is a view illustrating a state wherein an ascending rod is ascended by an ascending bar cable.

### BEST MODES FOR CARRYING OUT THE INVENTION

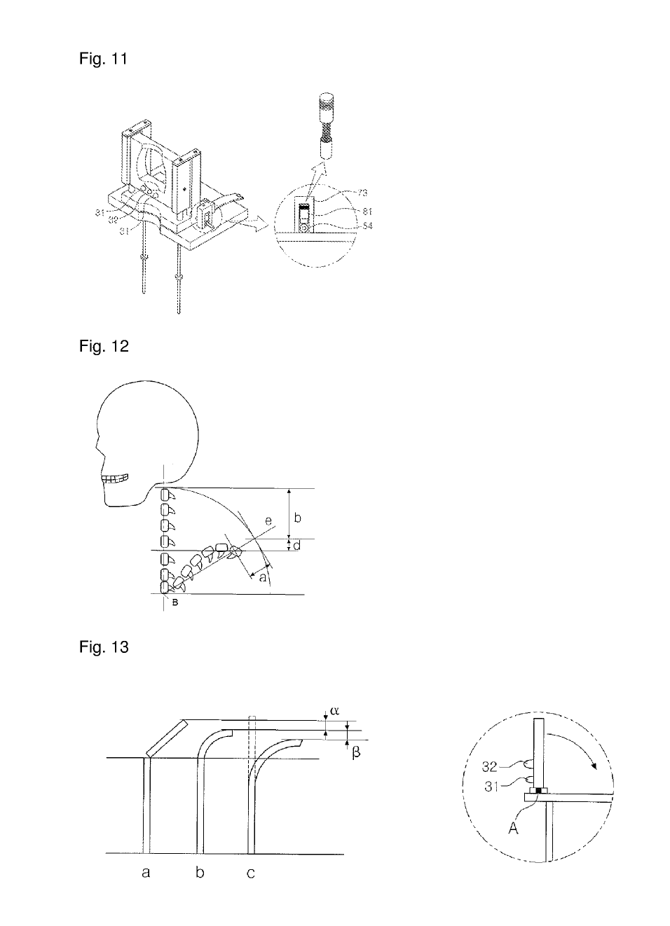

The more preferred embodiment is directed to FIG. 11 which is combined with FIGS. 5, 6 and 10.

In case of the contact plate in FIG. 5 forming the configuration in FIG. 11, it is configured to freely move in the forward and backward directions when a force is supplied to the back of the head.

A supporting point 56 is provided at both ends of a lower end portion of a backside in FIG. 6, wherein the supporting point 56 operates as a lever when the head is tilted backward as the force is supplied to the head, thus ascending the lower end portion. As illustrated in the state view, a first torsion spring 57 is inserted, wherein it is pushing in the opposite direction when the head rest moves backward.

Moreover, a spring 52 is configured to help the contact plate move downward with the aid of the operations of the supporting point, a supporting point roller 55, and a torsion spring roller 58, so it is able to allow the head to be mounted at the contact plate even when the neck is tilted.

FIG. 10 is a view illustrating a state where an upper plate and a lower plate in FIG. 9 have been engaged, wherein the upper plate is able to move back and forth.

As illustrated at the right side which shows in more details a fixture in FIG. 11, if there is not any pocket spring, the first torsion spring 57 at the backside of the head rest may remain bent downward (refer to FIG. 5B), a first rotary shaft 54 may position at the top of a support member groove, for which it is impossible to obtain a desired pulling effect.

A pulling operation may occur since the first rotary shaft 54 ascends along the groove formed in the middle of a support member 73, for which in order to obtain a desired pulling effect, the first rotary shaft 54 should ascend along the groove when in use since the rotary shaft position at a lower portion at normal times. FIG. 2 is a view illustrating the aforementioned configuration engaged with a chair. As illustrated therein, it is configured in such a way that the head rest can ascend when in use by installing a compression spring at a support rod 77 so as to obtain a desired pulling effect.

The above described configuration corresponds to the outline of the present invention, wherein the spring has been installed at three portions.

### MODES FOR CARRYING OUT THE INVENTION

The preferred embodiments which are not intended to limit the present invention will be described with reference to the accompanying drawings.

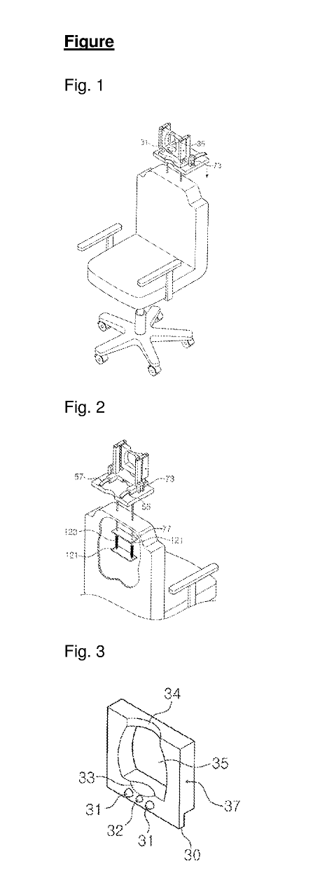

FIG. 1 is a schematic view of the present invention.

FIG. 2 is a view illustrating an internal configuration of a back plate.

As a key outline of the present invention, the present invention is configured in such a way that the exercise of the neck can be carried out as a head rest is pushed by a head, wherein the head rest corresponds to a combined configuration of a contact plate, a contact plate support member, a main body and a support plate, and at the same time the neck is pulled in the longitudinal direction.

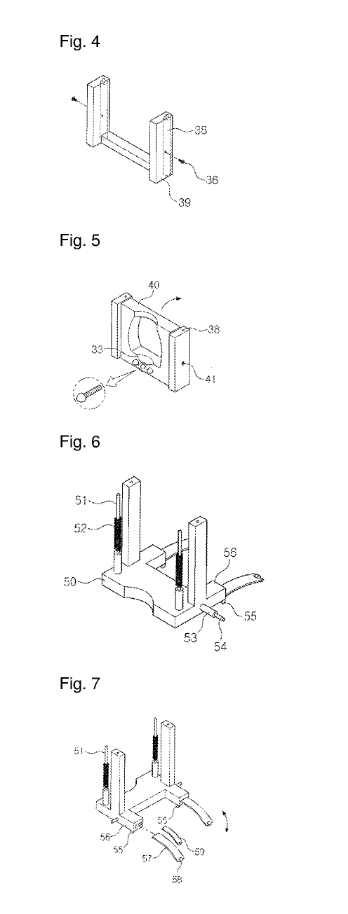

FIGS. 3 and 4 are views illustrating the configuration as a contact plate which directly contacts with the head. It is related to a contact plate support member which allows to help the head and the contact plate contact well with each other.

As illustrated in FIG. 4, a contact plate support through hole 38 is provided at both side surfaces in the inside of the support member, which is provided for the sake of an engagement with the main body as illustrated in FIG. 6.

The contact plate and the contact plate support member may be engaged using a coupling pin 36.

FIG. 5 is a state view illustrating the coupled configuration thereof.

As illustrated in FIG. 5, a contact plate is configured to freely move back and forth when a force is supplied to the back of the head.

FIG. 6 is a view illustrating a main body which has been engaged to the configuration in FIG. 5.

FIG. 6 is a view illustrating a front portion of the main body.

FIG. 7 is a view illustrating a rear portion of the main body.

Referring to FIG. 7, at both ends of a lower portion of the backside, there is a supporting point 56 which may operate as a lever when the head is tilted backward and may allow to ascend the lower end portion. It illustrates a state wherein the first torsion spring 57 is inserted, which is pushing in the opposite direction when the head rest is tilted backward.

In the present invention, the first torsion spring 57 is formed of a leaf spring. A small size torsion spring may be selectively used after the muscles of the neck have been strengthened using a second torsion spring 59. The left end portion in FIG. 7 illustrates a disassembled state of the torsion spring. When in use, it is inserted like the right end portion in FIG. 7. According to a situation, an assistant spring may be added or selected. In FIG. 7, it illustrates that a main spring is inserted.

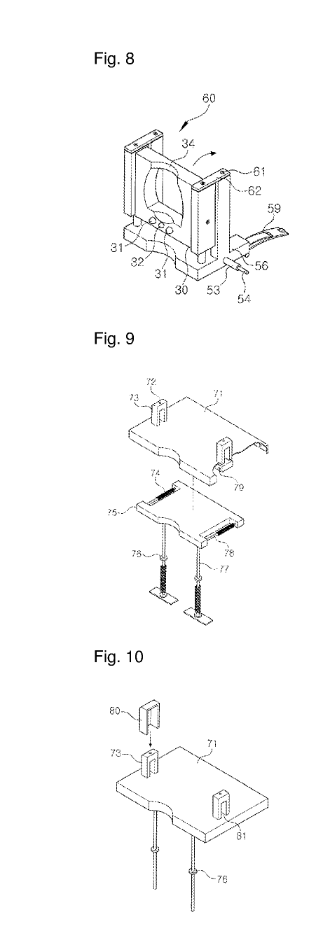

FIG. 8 is a view illustrating a combination of FIGS. 5 and 6.

FIG. 9 is a disassembled view illustrating a support plate which is inserted into the intermediate portion wherein the configuration in FIG. 8 is engaged to the chair.

The support plate in FIG. 9 may be formed of an upper plate and a lower plate. The upper plate may be formed of a support member 73 which are able to insert the portions of the first rotary shaft 54 and the ring in FIG. 8 so as to support the configuration in FIG. 8, and at a lower portion of the upper plate, there is provided a coupling rod insert hole to receive the lower plate.

At both sides of the lower plate in FIG. 9, there is provided a second coupling rod 78 which is able to insert the support plate spring 74.

FIG. 10 is a view illustrating a coupled state of the upper plate and the lower plate in FIG. 9, wherein the upper plate is able to move back and forth.

FIG. 11 is a view illustrating a combination of FIGS. 10 and 8, which corresponds to the head rest of the present invention.

As a feature in FIG. 11, a pocket spring is provided at the top of the support member 73.

As illustrated at the right portion which shows in details the fixture in FIG. 11, if the pocket spring is not provided, the first torsion spring 57 at the backside of the head rest may be bent downward (refer to FIG. 7), so the first rotary shaft 54 might position at the support member groove. For this reason, it is impossible to obtain a desired pulling effect.

A pulling operation may occur since the first rotary shaft 54 ascends along the groove formed in the middle of a support member 73, for which in order to obtain a desired pulling effect, the first rotary shaft 54 should ascend along the groove when in use since the rotary shaft position at a lower portion at normal times. FIG. 2 is a view illustrating the aforementioned configuration engaged with a chair. As illustrated therein, it is configured in such a way that the head rest can ascend when in use by installing a compression spring at a support rod 77 so as to obtain a desired pulling effect.

The above described configuration corresponds to the outline of the present invention, wherein the spring has been installed at three portions.

Generally, it may be possible to think that only one spring having a torsion operation may be provided at a typical head rest as illustrated at the right portion in FIG. 13, and the rotation might occur about the portion A which corresponds to the lower end portion. Such an operation, however, may not be available due to the shape of a human body. The problem is that only the cervical vertebral does not bend when the neck is tilted backward. Since the contact plate is equipped with a support rod 31 in order to pull the neck during an exercise, it is configured to carry out, to the maximum, the pulling with the aid of a contacting force with a predetermined portion of the neck.

The aforementioned reason will be described with reference to FIGS. 12 and 13.

When the neck is tilted, the cervical vertebral is not bent maintaining a straight line shape, and each of seven cervical vertebral is bent in a curved shape like a bow. More specifically, the point “B” in FIG. 12 corresponds to the 7^{th} cervical vertebral. As illustrated in the drawing, only the point “B” is not bent, but each joint is bent in cooperation with each other in a bow shape. When an action is carried out, wherein the neck is tilted backward, the cervical vertebral is not rotated maintaining a straight shape, more specifically, only the cervical vertebral is not moved, but a spine, in particular, a thoracic vertebral is moved. Consequently, the rotation radius may decrease by “a” when the rotation occurs by the line “e” as compared to when the motion occurs maintaining a straight shape. There may be a difference in the degree of descent. The descent may further occur by “d” in FIG. 12 as compared to when the straight motion occurs.

FIG. 13 will be described as follows.

The lower end portion corresponds to a spine, and the upper portion corresponds to a cervical vertebral of the neck.

The first part in FIG. 13 is illustrated assuming that both the spine and the cervical vertebral move straight. Only the 7^{th} cervical vertebral can be bent. In this state, the neck can hardly move.

The second part in FIG. 13 corresponds to an occasion wherein only the cervical vertebral is bent. In this case, the degree of motion is not large, and it is hard to push strongly. However, in this state, actually the neck can hardly move.

The third part in FIG. 13 corresponds to a phenomenon wherein such a situation may actually occur during the exercise, wherein the cervical vertebral, in particular, the thoracic vertebral is bent together backward.

In this way, a smooth neck exercise can be carried out, and a powerful exercise is available. It is possible to recognize that a large protruding portion of the back of the neck corresponding to the 7^{th} cervical vertebral is tilted backward, and the hands are wrapped around the back of the neck, so the motion can be carried out like the third part in FIG. 13. Here, the thoracic vertebral may be bent less, and the cervical vertebral may be bent more. For this reason, the rotary shaft may be defined at two portions, namely, at the thoracic vertebral portion and the cervical vertebral portion. More specifically analyzing, since each joint of the thoracic vertebral and of the cervical vertebral is bent a little bit, there may be a number of rotary shafts, and the position of the rotary shaft may frequently change based on the angle that the neck is tilted backward.

For this phenomenon, a simple manufacturing like in the first and second parts in FIG. 13 may be meaningless. In particular, if the support rod 31 is provided at a lower portion of the contact plate according to the present invention, it is almost hard to move.

As mentioned above, the spring corresponding to each exercise is provided at three portions.

If the neck is tilted by the line “e” in FIG. 12, there may be a further descent by “d” in FIG. 12, wherein it can be bent together with the spine, for which a further descent may be made by “β” in FIG. 13C. If it is pushed with a predetermined force, the spine may be naturally bent like a bow. In this case, it may be bent protruding forward, so another descent can be made further.

In case of an ordinary human body, the further descent phenomenon may occur by more than about 10 cm.

The first spring is provided to absorb such a phenomenon and may be formed of a back plate spring 123 (FIG. 2).

With a second spring configuration, a smooth exercise may be carried out along with a backward motion including the descent, which is illustrated in FIG. 13. This operation may be easily understood without a detailed description. In an actual exercise, a further backward motion may be necessary by 7-10 cm in case of an ordinary person. In order to absorb this phenomenon, there is provided a support plate spring 74 in FIG. 9.

A third spring configuration corresponds to a contact plate spring 52 (refer to FIG. 6). As illustrated in FIG. 10, if there is a rotation by the line “e” in the same drawing, the rotation radius may decrease by “a”.

If this spring is not installed, a phenomenon may occur, wherein the head may slide down the contact plate during the rotation.

Even through there are provided the descent spring (a back plate) corresponding to the first configuration and the support plate spring (FIG. 9) corresponding to the second configuration, since the cervical vertebral is bent making a sharp curve, it is impossible to avoid a sliding phenomenon unless the contact plate (FIG. 5) is pulled down to the position of the 7^{th} cervical vertebral.

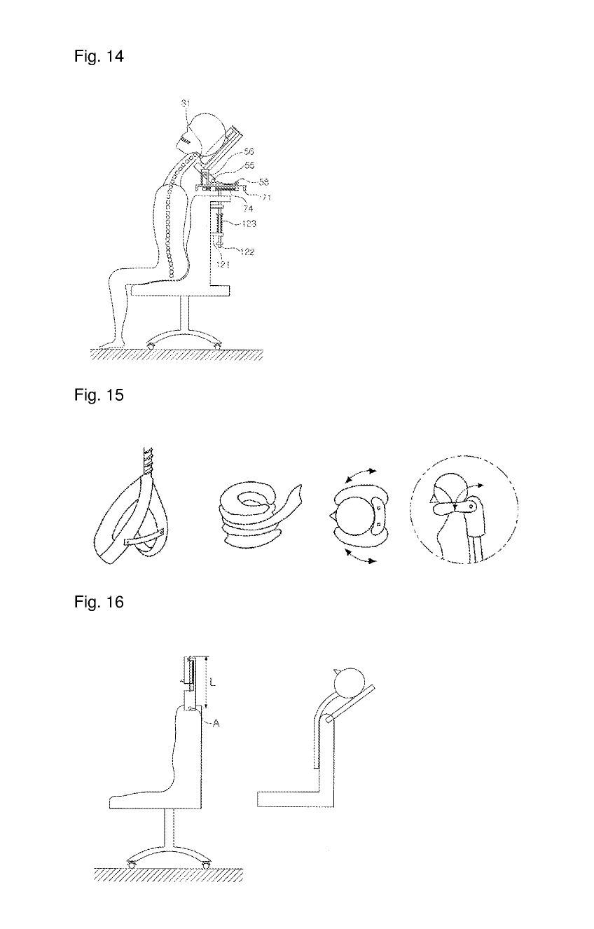

FIG. 14 is a view illustrating the whole descriptions on the pulling procedure during the exercise.

The configuration in FIG. 16 will be described in details.

As illustrated in FIG. 16, the head rest is made long (L in FIG. 16), and it may be possible to estimate that there may be a smooth rotation with the presence of only a contact plate spring. This way, however, may cause the cervical vertebral to sharply bend independent on the spine (in order to avoid the engagements of the spring to multiple portions), so it is impossible to avoid a phenomenon wherein the head slides on the contact plate. For this reason, since the support rod 31 may separate from the position of the acupuncture Fengchi, it is impossible to avoid a sliding phenomenon between the head the contact plate.

Referring to the right part in FIG. 16, since the cervical vertebral is bent sharply, the head may slide down the contact plate if it is bent too much, and then only the top of the head may contact with the contact plate.

This phenomenon may hinder the pulling effects and may cause a sliding uncomfortable friction, for which a desired exercise effect may not be obtained. In order to avoid this phenomenon, as illustrated in FIG. 5, there may be provided a rotation configuration of the contact plate 30 wherein the device configured along with the spring is able to press the contact plate spring 52 in FIG. 6.

In this way, the pulling may be carried out in a state where the head is always contacting closely with the contact plate, and the feeling when the head contacts can be stable.

The above mentioned reason is why the spring is installed at three portions.

These springs are able to provide a good pulling function. The pulling effects will be described below.

First, the supporting point 56 may provide a pulling effect when the head in FIG. 14 is bent backward. The supporting point 56 may ascend the lower portion of the head rest as it functions as a lever when the head rest rotates. Since it receives a strong weight load, a supporting point roller 55 may be disposed at a lower portion thereof for the sake of a smooth operation while avoiding a friction noise.

Second, the ascending operation may be assisted using the elasticity of the torsion spring when the torsion spring attached to an end portion of the supporting point is bent backward.

Third, as for the pulling operation of the back plate spring 123 in FIG. 14, even though the neck is bent at about 45°, the point of the acupuncture Fengchi where the support rod contacts, may receive a vertical force. Since the point where the head bone of the neck portion ends is formed grooved, and the head remains tilted, the support rod may push up vertically the neck portion.

For this reason, the back plate spring 123 may directly receive all the pushing force, which may consequently generate a pulling effect.

Since the cervical vertebral is bent and receives the force in the right angle direction, the 6^{th} and 7^{th} portions corresponding to the lower portions of the cervical vertebral may receive large force. More specifically, the main portions of the muscles used when the neck bends backward like a bow and pushes while causing a backward force, correspond to the 2^{nd}, 3^{rd}, 4^{th} and 5^{th} portions corresponding to the intermediate upper portions of the cervical vertebral (since these portions are bent a lot). The muscles of the 6^{th} and 7^{th} portions corresponding to the lower portions of the cervical vertebral may be bent less due to the natural structures, so they may receive smaller force. For this reason, the muscles at the lower portions where the muscles are less tightened can increase. Since most of the neck diseases occur at the 6^{th} and 7^{th} portions of the cervical vertebral, the aforementioned phenomenon may good at the therapy of the neck disease.

Subsequently, the pulling force corresponding to the force that the spring is pressed due to the reaction of the spring can be generated. In the conventional methods, since the pulling is carried out in a state where the neck is maintained in a straight shape, it is possible to make sure that the force can be intensively focused on the cervical vertebral as compared to when the whole portions of the cervical vertebral evenly receive the pulling force. For this reason, from the moment the neck is tilted backward, the cervical vertebral is going to slowly receive the force of the reaction of the back plate spring. As the angle increases higher and higher, the force may increase accordingly. This force may correspond to the force which may cause the neck portion to be pulled.

This means that the force is supplied to the muscles (due to the backward pushing operation), and the muscles can be strengthened while receiving the upwardly lifted force (the force of pulling the muscles).

In the present invention, the force of the reaction that the back plate spring ascends, can be received from the moment the neck is tilted backward. Since the muscles have been already hardened after the force was supplied to the neck, the pulling distance may be smaller as compared to the conventional method wherein any force is not supplied. As mentioned above, the extension carried out while the muscles are being strengthened and the pulling wherein any force is not supplied, may have absolutely different effects.

The muscles are able to memorize a predetermined repeating state. The pulling carried out while the muscles are being strengthened and the action wherein the ascent and descent are simply carried out without any force being supplied thereto, may have different muscle strengthening degrees during the neck exercise.

This phenomenon may occur for the same reason as in the occasion of the contact plate spring 52 (FIG. 6). At this time, the force can be received always in the vertical direction irrespective of the tiling angle.

Such an operation can be obtained since the contact plate and the head always move in a contacted state in parallel with the aid of the contact plate coupling pin 36.

The action when the pulling is carried out concurrently during the exercise, so far, has been described above.

In another embodiment of the present invention, there may be provided a device for carrying out an acupressure during the neck exercise.

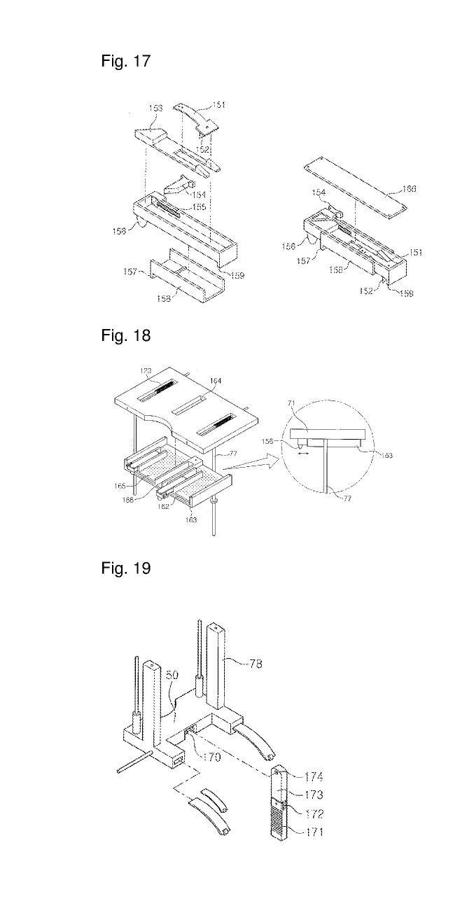

If the acupressure rod is disposed beneath the lower surface of the support plate in FIG. 12, the shoulder can receive acupressure by the force generating when the head rest descends. This is illustrated in FIGS. 17 and 18.

The portion below the support plate in FIG. 18 corresponds to an acupressure rod fixing plate 163. An acupressure rod in FIG. 17 is engaged at the acupressure rod fixing plate 163 and is engaged to the support plate, thus finishing the engagement. The acupressure rod is made movable in forward, backward, leftward and rightward directions in FIG. 17.

The left part in FIG. 17 corresponds to a disassembled view, and the right part in FIG. 17 corresponds to an engaged view.

A first bolt 153 corresponding to the second part from FIG. 17 to which the acupressure rod 41 has been attached, is engaged, and a fixing pin spring 151 is fixed with a piece, and a cover plate 160 is covered, thus finishing the engagement.

The fixing pin 152 remains at usual times protruded and is fixedly inserted in a hole formed at the acupressure rod fixing plate. In this state, if the handle 154 is pressed, the acupressure pin may be lifted upward by a slide portion of a triangular shape at an end portion of the first bolt 153, by which the acupressure can be movable freely.

The part at a right lower portion in FIG. 17 corresponds to a rail box 158.

An acupressure rod main body may be inserted in the rail box 158, so it can be movable back and forth. A rail groove 162 may be formed grooved like a rail at a front portion of the acupressure rod fixing plate 163. A rail protrusion 157 disposed at a lower end portion of a rail cap is movable leftward and rightward being inserted into the rail groove 162. When the handle 154 is touched, it can be movable to a desired position in forward, backward, leftward and rightward directions. If the handle is released, it will be directly fixed in place. If the acupressure device remains protruded at usual times, the performance of the chair may be inhibited. As illustrated in FIG. 18, the acupressure plate is preferably hidden under the support plate and may be taken out and used, if necessary.

When handling, the right part is handled with a left hand, and the left part is handled with a right handle, so the positions of the handle are determined based on the aforementioned principle.

The reason why the rail groove 162 is provided is that it needs to prevent a problem wherein the configuration of a blood acupuncture of a shoulder is not flat, so it may be easily separated from a desired position as force is supplied. So, the acupressure rod can contact at a desired position without being pushed since the rail protrusion 157 has a predetermined length in leftward and right ward directions.

Most of neck disease patients have pains in the shoulder. The present invention is directed to a device which may frequently use a head rest when the tired shoulder is stimulated for a user to feel comfortable. As illustrated in FIG. 1, both sides of the top of the back plate are lowered for the shoulder to be supported thereon to enhance the effects of the acupressure. The chest is widened and then both the shoulders may be supported thereon during the exercise, by which the effects of the acupressure can be doubled. The effects of the acupressure may be different if the shoulders are supported by the lower end portion or not supported. This portion may cause the check to be widened if both the shoulders are supported thereon when taking a rest at normal times.

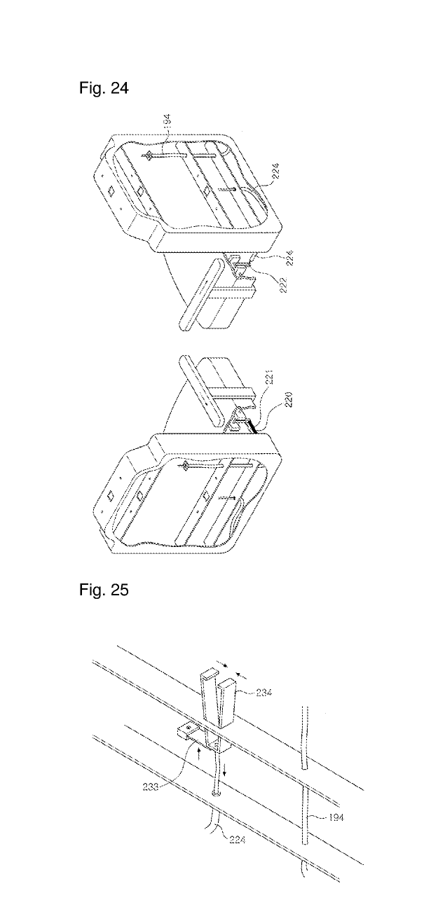

According to another embodiment of the present invention, the pulling force may be further increased in such a way to pull backward the arm rest, the configuration of which is illustrated in FIGS. 19B and 24.

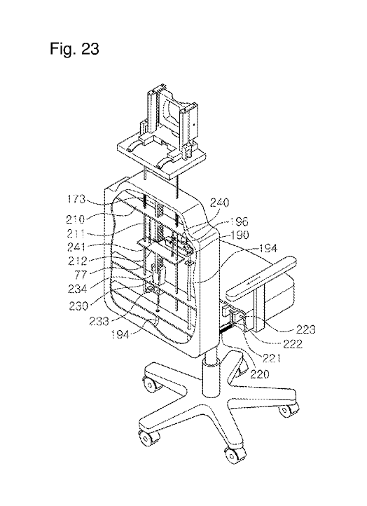

The whole operations are illustrated in FIG. 23. According to the outline thereof, the pulling may be further carried out using a cable corresponding to a driving force transfer cable, in such a way to dispose an advancing lever 222 at a lower end of the second rotary shaft 223 when the arm rest is pulled backward.

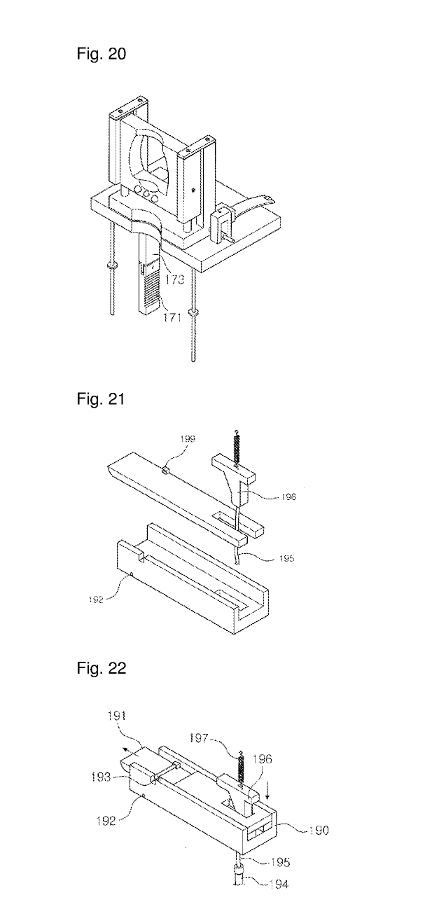

As illustrated in FIG. 19, a groove 170 to which the ascending rod 173 is engaged, may be formed at a lower end of a support 50 which is equipped with a head rest support point, the configuration of which is illustrated in FIG. 20. Since the head rest is movable back and forth, the ascending rod is equipped with a joint 172 at an intermediate portion thereof to match therewith. As illustrated in FIG. 18, ascending rod passage holes 164 and 166 are formed long at front and rear portions.

As illustrated in FIG. 23, the support rod 77 of the head read is manufactured long and is engaged passing through a fixing bar 210 which is attached to the upper and lower portions of the back plate and is disposed lifted upward using an extension spring 211.

The operations which may further cause the effects of acupressure will be described below.

A T-shaped bar 212 having teeth at its both sides is tightly fixed using a bolt at an intermediate portion of the support rod 77. A biter 234 is inserted in a fixing member 230 at a lower portion, wherein the biter 234 is able to bite the T-shaped bar 212 and move downward when pulling the arm rest of the left side of the chair. At normal times, the torsion spring 233 at a lower side is pushing upward the biter, so the T-shaped bar and the biter are spaced-apart from each other, by which the biter does not interfere with the operation of the T-shaped bar 212. If the arm rest is pulled, the biter may be narrowed and bite the T-shaped bar 212 and descend. Since it is connected to the acupressure and support rod, the support rod can descend together. If the arm rest is released, it will return back to its original position with the aid of the operations of the return spring 220 disposed at the bottom plate of the chair and the torsion spring 233 at a lower end of the biter, and the biter may be widened, thus releasing the T-shaped bar 212.

The biter may be made of an elastic material so that teeth can be open.

The procedure of the pulling wherein the head rest ascends, will be described.

Different from the acupressure, the pulling needs an ascent, for which as illustrated in FIG. 22, the ascending rod is ascended using the ascending bar 190. It can be ascended with the aid of the operation of the connected cable when pulling the arm rest. In this case, as illustrated in FIG. 22, a sliding trigger 196 is used for the sake of neck exercise. The cable 194 is connected to the arm rest of the right side. Not illustrated in the drawings, in case of the arm rest of the left side, it may be installed in a structure which is able to help the further descents of the acupressure rod and the head rest by descending the biter.

FIG. 21 is a disassembled view illustrating the ascending bar. A second bolt 191 which is able to bite the ascending rod 173 disposed inside of the top of the ascending bar, may correspond to a third torsion spring 193 illustrated in FIG. 22.

Since the second bolt remains pushed backward by the third torsion spring, it does not contact at normal times with the ascending rod 173. If the arm rest is pushed backward, the wire 195 is pulled, so the sliding trigger 196 will descend, while forwardly advancing the second bolt 191, whereby it can bite the ascending rod 173. In this way, the effects of exercise can be enhanced since the second bolt 191 is moved upward or downward little by little by the rotary shaft with the aid of the third rotary shaft 192.

Since the ascending rod 173 fixes only a lower end portion of the joint, and its upper portion should be freely movable back and forth, only the lower end portion is fixed, and as illustrated in FIG. 23, it can be supported through the support rod fixing bar 210.

The stage where the arm rest is used, may correspond to a state wherein the neck has been already tilted a lot. Since the ascending rod has been already descended, the pulling may be available even though the ascending section is not much during the ascending, and the ascending lever 190 may be increased in a state where the ratio of the leverage is high, by which it is possible to achieve a desired purpose using a smaller force.

In this way, it is possible to obtain a strong force at any time. If the ascending force is stronger and stronger, the neck should withstand with the force increased accordingly, so the muscles of the neck can be strengthened during the aforementioned procedure.

In the present invention, since the contact plate 30 has a movable function, a motion is available, wherein the exercise width is small, namely, the neck is just nodded little by little in a state where the neck has been tilted a lot backward. The present invention is able to provide a usefulness which is different from the conventional method wherein the neck can hardly move.

This operation may be a significant way to increase the interval of the narrowed intervertebral discs. If the arm rest is additionally used, such effects can be more enhanced. It is possible to widen the interval of the intervertebral discs which have been narrowed for a short period.

The action wherein the neck is just nodded in a state where it is being strongly pulled, may correspond to a principle wherein a large rock can move if it is moved little by little using a lever when it needs to move such a large rock. In this way, it is possible to greatly widen the interval of the narrowed intervertebral discs.

The method for fixing the arm rest will be described.

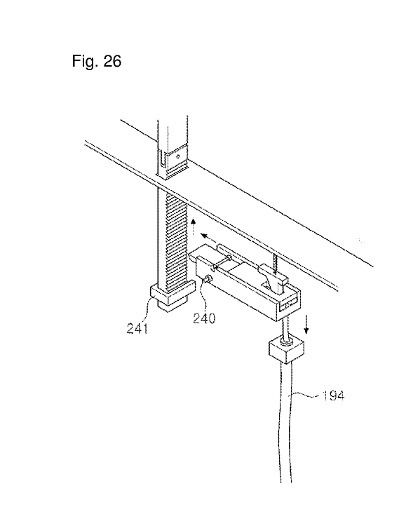

FIGS. 24, 25 and 26 are detailed views for describing the movements of the bite and the ascending bar installed at the arm rest part.

The arm rest is equipped with a return spring 220 so that it cannot be tilted backward at normal times, whereby the arm rest can automatically return back to its original position. As the left arm rest is moved backward, it can be further descended by the biter. The ascending lever can ascend by the right arm rest, and it can return back to its original position with the aid of the operation of the return spring after the exercise has been finished.

As for the use of the arm rest, since it can be additionally used in a state where the neck has been tilted a little, it may function as an arm rest in a state where the neck is not tilted backward.

The driving force transfer cable is one which is being widely used at a bike or a vehicle. It may be configured in such a way that a wire is just inserted in the inside of a steel pipe which can be bent well, but does not have any expansion and contraction.

It is possible to recognize during the use of the present invention that the present invention is directed to an action wherein the neck is tilted backward. For this reason, the present invention is good at correcting a turtle neck problem which means that the neck is dropped forward. Since the neck can move smoothly only in case where the chest has been opened wide, the present invention may allow to widen the chest.

All the joints are surrounded by muscles, and so are the neck muscles.

If the knee joints are worn out, a cycling and swimming, in general, are recommended. Since the muscles surrounding the joints are strengthened, the knee joints can be cured.

Even through the cycling or swimming does not have any pulling action, the muscles can be strengthened, and the interval between joints can be widened since muscle fibers are surrounded by muscle fascia which are flexible, by which the muscles can be strengthened in a widthwise direction as well as in a lengthwise direction, which means that if the neck muscles are strengthened, the pulling effects can be obtained naturally. For this reason, the present invention may provide a great effect only in terms of the strengthening of muscles even without considering the pulling effect. Since the neck interconnects the head and each part of a body, it is possible to say that if the neck works well as a bridge component connecting them, a good health will come. If the neck receives an over load, a person may have a pain in the shoulder since the shoulder has an over load due to the weak neck. There is no way to basically cure such problems without strengthening the neck muscles.

Since most of the neck muscles are at the back of the neck, the exercise wherein the neck is tilted backward, may become an optimum condition for preventing and curing a cervical vertebral disease.

In the present invention, most of the parts of the device are hidden under the back plate and the chair, the exterior is same as a typical chair, so the user does not feel any repulsion with respect to the exterior.

When the device is used, it needs to just tilt the neck backward without any special procedure.

In terms of accessibility, it is possible to easily and naturally make an access to the chair since we use the chair all days.

### INDUSTRIAL APPLICABILITY

First, the supporting point 56 is able to cause a pulling effect when the neck is tilted backward as illustrated in FIG. 14. The supporting point 56 may function as a lever when the head rest rotates, thus ascending a lower end portion of the head rest. Since it receives a strong weight load, there is provided a support point roller 55 at its lower end portion for the sake of a smooth operation while avoiding a friction noise.

Second, the torsion spring attached to an end portion of the supporting point may promote an ascending operation with the aid of the elasticity of the torsion spring when the neck is tilted backward.

Third, as for the pulling operation of the back plate spring 123 in FIG. 14, even though the neck is bent at about 45°, the point of the acupuncture Fengchi where the support rod contacts, may receive a vertical force. Since the point where the head bone of the neck portion ends is formed grooved, and the head remains tilted, the support rod may push up vertically the neck portion.

For this reason, the back plate spring 123 may directly receive all the pushing force, which may consequently generate a pulling effect.

Since the cervical vertebral is bent and receives the force in the right angle direction, the 6^{th} and 7^{th} portions corresponding to the lower portions of the cervical vertebral may receive large force. More specifically, the main portions of the muscles used when the neck bends backward like a bow and pushes while causing a backward force, correspond to the 2^{nd}, 3^{rd}, 4^{th} and 5^{th} portions corresponding to the intermediate upper portions of the cervical vertebral (since these portions are bent a lot). The muscles of the 6^{th} and 7^{th} portions corresponding to the lower portions of the cervical vertebral may be bent less due to the natural structures, so they may receive smaller force. For this reason, the muscles at the lower portions where the muscles are less tightened can increase. Since most of the neck diseases occur at the 6^{th} and 7^{th} portions of the cervical vertebral, the aforementioned phenomenon may good at the therapy of the neck disease.

In the present invention, since the action wherein the pressing is repeatedly carried out with a neck, it is possible to obtain the same effects as when a dumbbell is lifted up with the neck. The amount of the muscles can be greatly increased as compared to when doing a free exercise, which may provide a basic resolution to a neck disease.

When the neck is pushed backward, since a good pulling effect is obtained, it is possible to concurrently obtain two effects at a time. As another effect, anyone is able to conveniently do an exercise, which is able to provide a good exercise efficiency. The tools in a physical therapy room cannot provide any exercise effect, and it is not easy for anyone to do exercise using them. Since the present invention uses a chair that we can use all the time in life, it is very easy to do exercise. The exercise can be easily carried out any time when working at an office or when driving a vehicle, and only the way to do exercise is just to tilt the head backward.

1. A chair having a neck exercise support for a neck exercise, which is provided at the top of a chair, comprising:
a contact plate which is to be in contact with the head;
a central hole which forms an empty space in the center of the contact plate;
a first insert hole which transversely penetrates the interior of the contact plate;
a contact plate support which is configured so as to support the contact plate;
a second insert hole which is transversely formed in the center of the contact plate support to correspond to the first insert hole of the contact plate;
a coupling part which penetrates the first insert hole and the second insert hole;
a third insert hole which is formed vertical to the second insert hole; and
a pair of first coupling rods which are coupled with a contact plate support coupling hole, wherein the contact plate is coupled via the coupling part to the contact plate support, and the contact plate support coupled with the coupling part is connected via the first coupling rod.

2. The chair of claim 1, wherein a neck acupressure rod 32 is disposed below the contact plate.

3. The chair of claim 1, wherein the coupling part is formed of a coupling pin.

4. The chair of claim 1, wherein a curved part 34 corresponding the shape of the neck is provided at the front sides of the contact plate and the neck exercise support for the neck to be mounted thereon.

5. The chair of claim 1, wherein the first coupling rod further includes a contact plate spring.

6. The chair of claim 1, wherein the neck exercise support includes at its backside a spring having a predetermined elasticity.

7. The chair of claim 6, wherein the spring is formed of a torsion spring.

8. The chair of claim 1, further comprising a first rotary shaft which is disposed in a vertical direction with respect to the first coupling rod.

9. The chair of claim 8, wherein a bottom plate of the neck exercise support is formed extended about the first rotary shaft.

10. The chair of claim 9, further comprising a support plate having a neck exercise support groove in which the first rotary shaft is inserted.

11. The chair of claim 10, wherein an assistant support plate is disposed below the support plate.

12. The chair of claim 11, wherein the assistant support plate includes a second coupling rod for the sake of a connection with the support plate.

13. The chair of claim 12, wherein a corresponding engaging rod insert hole is provided for the sake of a connection with the second coupling rod.

14. The chair of claim 12, wherein the second coupling rod includes a support plate spring.

15. The chair of claim 13, wherein the assistant support plate includes a support rod for the sake of an engagement to a main body of the chair.

16. The chair of claim 14, wherein the support rod further includes a back plate spring.

17. The chair of claim 10, wherein an elastic means is provided inside of the neck exercise support groove.

18. The chair of claim 17, wherein the elastic means is formed of a picket spring.

19. The chair of claim 15, wherein an acupressure rod fixing plate is disposed below the assistant support plate.

20. The chair of claim 19, wherein the acupressure rod fixing plate includes a shoulder acupressure rod part.

21. The chair of claim 20, wherein the shoulder acupressure rod part includes a bolt, a handle installed at an end of the bolt so as to allow the bolt to move back and forth, and a fixing pin which is installed at the other end of the bolt so as to lock or unlock the bolt, wherein there are provided the bolt and a handle shoulder acupressure rod.

22. The chair of claim 21, wherein the shoulder acupressure rod part includes a rail box for the sake of an engagement with the acupressure rod fixing plate.

23. The chair of claim 21, wherein the shoulder acupressure rod part is connected via an ascending rod, so it can ascend or descend via a chair handle.

24. The chair of claim 23, wherein there is provided an ascending lever to ascend or descend the ascending rod.

25. The chair of claim 24, wherein an ascending and descending locking part includes a second bolt, a sliding lock which is able to allow the second bolt to move back and forth, and a cable which is able to allow the sliding lock to move back and forth, wherein a third rotary shaft is provided at the ascending lever for the ascending lever to ascend when the cable is pulled.
